(19) United States
(12) Patent Application Publication
(10) Pub. No.: US 2009/0254244 A1
(43) Pub. Date: Oct. 8, 2009

(54) System and Method for Detecting a Pitch Rate Sensor Fault

(76) Inventors: Li Xu, Novi, MI (US); Hongtei Eric Tseng, Canton, MI (US); Joseph Carr Meyers, Farmington Hills, MI (US)

Correspondence Address: ANGELA M. BRUNETTI, PLLC, 3233 Lake Forest Dr., Sterling Heights, MI, 48314, US

(21) Appl. No.: 12/062,762

(22) Filed: Apr. 4, 2008

(51) Int. Cl. B60W 40/12

(52) U.S. Cl. 701/34

(57) ABSTRACT

A system and method for detecting a fault in a pitch rate sensor onboard a vehicle. Signals, including a steering wheel angle, a yaw rate, a roll rate, a longitudinal acceleration, a lateral acceleration, and a vehicle speed, are processed in a controller to validate a pitch rate signal. Upon detection of a fault in the pitch rate signal, the system and method will determine a process in which to minimize negative effects of the pitch sensor fault. The system and method will then direct the controller to select a process, such as a direct shutdown, a slow shutdown or replace a signal, in a relevant control system, based on the determination.

### TECHNICAL FIELD

The inventive subject matter relates generally to automotive vehicle sensors, and more particularly to a system and method for detecting a pitch rate sensor fault.

### BACKGROUND

Vehicle control systems enhance vehicle stability and tracking performance in critical dynamic situations. Examples include yaw stability, roll stability and integrated vehicle dynamic control systems. Knowledge of vehicle states is very important to the effectiveness of these control systems and successful vehicle dynamic control requires accurate determination of the vehicle states. For example, in yaw stability control systems, sideslip angle is critical for detecting sliding or skidding in a vehicle. Because a normal yaw rate may be sensed in a yaw rate sensor even under sliding or skidding occurrences, the sideslip angle is an important parameter to track. Another example is in roll stability control systems where roll angle is used to construct feedback pressure commands and combat detected roll instability. In each of these examples, the states are not directly measured and the control systems rely on estimations of the vehicle states.

For vehicle state estimation purposes, at least four motion sensors are employed. These include, but are not limited to, a longitudinal accelerometer, a lateral accelerometer, a yaw rate sensor and a roll rate sensor. Because these sensors are easily affected by disturbances such as road grades and vehicle pitch induced by suspension deflection, an additional sensor called a pitch rate sensor is typically used. The pitch rate sensor signal can be used to help compensate for the disturbances and improves estimation accuracy of the vehicle states.

However, pitch rate sensor faults may mislead the control system and result in unwanted effects, such as unintended vehicle braking, reduced performance, or even loss of stability. Therefore, pitch rate sensor fault modes should be rapidly diagnosed and indicated so that measures can be taken to resolve possible system error.

There is a need for a system and method of detecting pitch rate sensor fault in an automotive stability control system to provide an accurate determination of vehicle states. The need is for a system and method that can be applied to a variety of vehicles and vehicle designs without tuning or adaptive needs. Further, a need exists for a system and method that is able to detect a fault independent of specific fault modes and to detect a fault that would otherwise not be detectable from merely checking electrical specifications of the sensor, such as an in-range sensor fault.

### SUMMARY OF THE INVENTION

The system and method detect a fault in a pitch rate sensor onboard a vehicle. Signals, including a steering wheel angle, a yaw rate, a roll rate, a longitudinal acceleration, a lateral acceleration, and a vehicle speed, are processed in a controller to validate a pitch rate signal. Upon detection of a fault in the pitch rate signal, the system and method will determine a process in which to minimize negative effects of the pitch sensor fault. The system and method will then direct the controller to select a process, such as a direct shutdown, a slow shutdown or replace a signal, in a relevant control system, based on the determination.

In one aspect of the invention, a fault detection module senses reference signals from a plurality of sensors. The sensed signals are used to cross-check pitch rate sensor validity. In a further aspect of the invention, a method of fault detection utilizes a kinematic relationship between the sensors and rates of changes of Euler angles to define a reference pitch angle, compensate a pitch rate signal within a controller and in accordance with current vehicle conditions, compare the compensated pitch rate signal to the reference pitch angle and determine whether a pitch rate sensor fault is suspected. In yet another aspect of the invention, upon suspicion of a fault, the method and system directs a controller to shut down either a safety system, or a sub-system of the safety system.

Sensor fault is not always detectable by self-test or electronic monitoring. These methods rely on the fault to violate sensor specifications. However in-range signal faults may occur and therefore, a redundancy check is warranted, especially for critical safety systems. The inventive subject matter provides a system and method for such an event.

Other advantages and features of the inventive subject matter will become apparent when viewed in light of the detailed description of the preferred embodiment when taken in conjunction with the attached drawings and appended claims.

### BRIEF DESCRIPTION OF THE DRAWINGS

FIG. 1 is a diagrammatic view of a vehicle with variable vectors and coordinate frames according to the inventive subject matter;

FIG. 2 is a block diagram of a fault detection system according to the inventive subject matter; and

FIG. 3 is a flow diagram of a method for fault detection according to the inventive subject matter.

### DETAILED DESCRIPTION

In the following figures, the same reference numerals will be used to identify the same components. The inventive subject matter may be used to augment a rollover control system for a vehicle, or a yaw control system, either of which are typically electrically actuated braking systems in automotive vehicles. The inventive subject matter could also be used in any suspension or steering system that could benefit from improved sensing of vehicle attitude. The inventive subject matter will be discussed below in terms of preferred embodiments relating to an automotive vehicle moving in a three-dimensional road terrain.

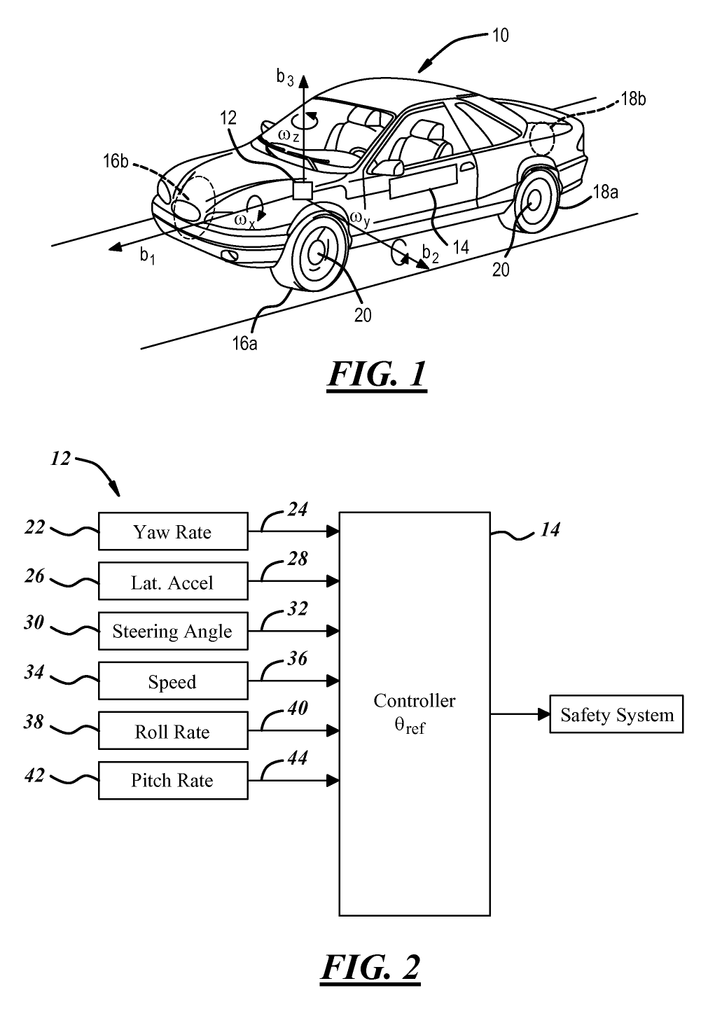

Referring to FIG. 1, various operating parameters and variables used by the inventive subject matter are illustrated as they relate to the application of the inventive subject matter to a ground based motor vehicle 10. Those skilled in the art will immediately recognize the basic physics represented by this illustration, thereby making adaptation to different types of vehicles and vehicle control systems easily within their reach.

The vehicle 10 has a sensing system 12 coupled to a control system 14. The sensing system 12 uses a yaw stability control sensor set that includes a yaw rate sensor, a lateral accelerometer, a steering angle sensor, a speed sensor, and a pitch rate sensor. The speed sensor 20 is typically mounted at each wheel 16a, 16b, 18a, 18b and the other sensors in the set are typically mounted on the center of gravity of the vehicle 10. The angular rates of the vehicle are denoted as ωₓ for the roll rate, ω_{y} for the pitch rate, and ω_{z} for the yaw rate. Also included in the following discussion are the Euler angles of the vehicle frame b₁, b₂, and b₃ denoted by θₓ, θ_{y}, and θ_{z}.

Referring to FIG. 2, the sensing system 12 includes a yaw rate sensor 22 for detecting a yaw rate and providing a yaw rate signal 24, a lateral accelerometer 26 for providing a lateral acceleration 28, a steering angle sensor 30 for providing a steering angle 32, a speed sensor 34 for providing a speed 36, a roll rate sensor 38 for providing a roll rate 40, and a pitch rate sensor 42 for providing a pitch rate 44. The signals 24, 28, 32, 36, 40, 42 are provided to controller 14.

Using a kinematic relationship between the sensors 22, 26, 30, 34, 38 and the Euler angles, θₓ, θ_{y} and θ_{z}, and operating under the assumption that the rate of rotation of the earth is negligible, state equations for vehicle motion can be written as:

\dot{θ}=ₓ=ωₓ+(ω_{y}·sin θₓ+ω_{z}·cos θₓ)·tan θ_{y} (1)

\dot{θ}_{y}=ω_{y}·cos θₓ−ω_{z}·sin θₓ (2)

\dot{v}ₓ=aₓ+ω_{z}·v_{y}+g·sin θ_{y} (3)

\dot{v}_{y}=a_{y}−ω_{z}·vₓ−g·sin θₓ·cos θ_{y} (4)

In the state equations, vₓ is a longitudinal velocity, v_{y} is a lateral velocity, θₓ is a roll angle, and θ_{y} is a pitch angle. An angular velocity, ω, of the vehicle is typically measured by gyroscopic sensors fixed to the vehicle body and is made up of a roll rate ωₓ, a pitch rate ω_{y}, and a yaw rate ω_{z} shown in FIG. 1. Also in the equations are a longitudinal acceleration aₓ, a lateral acceleration a_{y}, a gravitational constant, g, a spring stiffness (also called a pitch stiffness) of the suspension, k, a pitch damping coefficient, c, a total mass of the vehicle, M, a pitch moment of inertia, I_{y}, and a distance between the center of gravity of the vehicle body and a roll center of the vehicle body, h.

The state equations are fundamental equations that govern the motion of the vehicle. Using the state equations in accordance with the kinematic relationship between the sensors and the Euler angles, the controller 14 of the inventive subject matter determines a reference pitch angle, θ_{ref}. The reference pitch angle is determined by using signals other than the pitch rate signal 44. Therefore, the reference pitch angle θ_{ref} is used to verify the validity of the pitch rate signal 44 from the pitch rate sensor 42. The reference pitch angle θ_{ref} is defined as a vehicle pitch angle in an inertial frame, or the angle between vehicle body longitudinal axis and a horizontal axis. The horizontal axis is perpendicular to a vertical gravitational axis in a longitudinal plane of the vehicle centerline. The reference pitch angle θ_{ref} is independent of the pitch rate 44 of the vehicle pitch angle, and therefore is defined as a reference.

The reference pitch angle θ_{ref} is generated within the controller 14 through kinematic relationships between various signals. There are several different ways in which the reference pitch angle θ_{ref} may be generated.

In one example the reference pitch angle θ_{ref} is generated using longitudinal acceleration, yaw rate, lateral velocity and vehicle pitch angle. The vehicle pitch angle can be calculated according to equation (5):

$$sin {θ}_{y} = \frac{{\dot{v}}_{x} - {a}_{x} - {ω}_{z} \cdot {v}_{y}}{g} \qquad ( 5 )$$

Longitudinal velocity, vₓ can be obtained fairly accurately from wheel speed sensors when wheel slip is small. Thus, longitudinal acceleration, vₓ (with a dot over v) is possible to obtain. However, lateral velocity, v_{y} is, generally, not easily obtained from current production vehicles. This may be possible with advancements in the future. To date, for many vehicle maneuvers, v_{y} is small and can be considered negligible. Therefore, for many maneuvers, the reference pitch angle θ_{ref} can be determined by Equation (6):

$$sin {θ}_{yref} = \frac{{\dot{\hat{v}}}_{x} - {a}_{x}}{g} \qquad ( 6 )$$

Further refinements to the reference pitch angle θ_{ref} may be made by applying steering wheel angle information, 32. The introduction of steering wheel angle information reduces the approximation error due to the negligence of the dynamic term ω_{z}*v_{y}, in Equation 5.

In another example, the reference pitch angle may be generated within the controller through the kinematic relationship between roll rate and yaw rate during steady state vehicle turning (ω_{z}=constant) through learning logic as follows in Equations (7) and (8):

$$\begin{matrix}{ω}_{xtemp} = {ω}_{x} + {ω}_{z} \cdot tan {θ}_{yref} & ( 7 ) \\ \frac{d ( tan {θ}_{yref} )}{d t} = - γ \cdot {ω}_{xtemp} \cdot {ω}_{z} & ( 8 )\end{matrix}$$

During a steady state turning, the true vehicle roll rate ωₓₜₑₘₚ, given by equation (7), should be zero. If ωₓₜₑₘₚ is found not to be zero, there must be an error in the calculation of θ_{ref}. Then, in equation (8), θ_{ref} is automatically adjusted or re-calculated to drive ωₓₜₑₘₚ to zero. n Equations (7) and (8), ωₓₜₑₘₚ is a temporary variable, and γ is a learning rate.

Yet another determination of the reference pitch angle may be generated within the controller using the dynamic relationship between longitudinal acceleration experienced by the vehicle body and suspension pitch motion. A mathematical representation is shown in Equation (9) as:

$$\frac{d}{d t} [ \begin{matrix}{θ}_{y} \\ {\dot{θ}}_{y}\end{matrix} ] = [ \begin{matrix}0 & 1 \\ - k & - c\end{matrix} ] [ \begin{matrix}{θ}_{y} \\ {\dot{θ}}_{y}\end{matrix} ] + [ \begin{matrix}0 \\ M / {I}_{y} \cdot h\end{matrix} ] \cdot {a}_{x} , \qquad ( 9 )$$

where k is the spring stiffness (or pitch stiffness of the vehicle suspension) and c is the pitch damping coefficient of the suspension. M is the total mass of the vehicle body, I_{y} is the pitch moment of inertia, and h is the distance between the body center of gravity and a roll axis. SAE J670e Vehicle Dynamics Terminology 9.4.28 defines roll center as the point in the transverse vertical plane through any pair of wheel centers at which lateral forces may be applied to the spring mass without producing suspension roll. The roll axis is a line that connects the front and rear roll centers and that the vehicle spring mass rotates about.

After obtaining the reference pitch angle θ_{ref}, controller 14 compensates the pitch rate signal 44 and generates a compensated pitch rate signal 48. The pitch rate signal is compensated within the controller 14 for all valid signal biases. A valid signal bias refers to a bias that may occur due to either electrical noise within a sensor specification or mechanical disturbance from road conditions and vehicle maneuvering. For example, a vehicle roll angle during a turn will induce a measurement bias due to the difference between inertial frame and body frame. To illustrate:

\dot{θ}_{y}=ω_{y}·cos θₓ−ω_{z}·sin θₓ=cos θₓ·(ω_{y}−ω_{z}·tan θₓ) (10)

Suppose that Euler pitch rate θ_{y} (with a dot over θ) is zero during a certain vehicle maneuver when the vehicle is not experiencing pitch motion. The pitch rate sensor may have non-zero input due to a roll angle alignment:

ω_{y}=ω_{z}·tan θₓ (11)

which needs to be compensated.

The vehicle pitch rate signal averages zero over a long period of time. Therefore, electrical long-term bias can be adjusted with a minute adjustment at each sampling time. Similarly, mechanical long-term sensor alignment roll angle can be updated with a minute adjustment at each sampling time during vehicle turning, i.e. ω_{z}≠0. Chattering occurs with this approach. Therefore, the adjustment should be small enough to prevent the chattering magnitude from exceeding a desired accuracy. A small adjustment restricts the adaptation speed. One skilled in the art will realize that the minute adjustment is only one way in which to make the adjustment. Numerous other methods may be used to make adjustments, such as sliding mode control, which can also be applied without departing from the scope of the inventive subject matter.

The controller 14 compares the compensated pitch rate signal to the reference pitch angle θ_{ref} and should a fault be suspected, logic is applied to determine whether a fault condition is indicated. Upon indication of a fault condition, a fault flag is set and a driver indication of pitch rate sensor problems is provided.

The controller responds to the fault flag in at least one of several methods. The controller may shut down the safety system or any subsystem of the safety system, such as yaw/roll stability control. The controller may compensate for information that would normally be obtained from the pitch rate sensor.

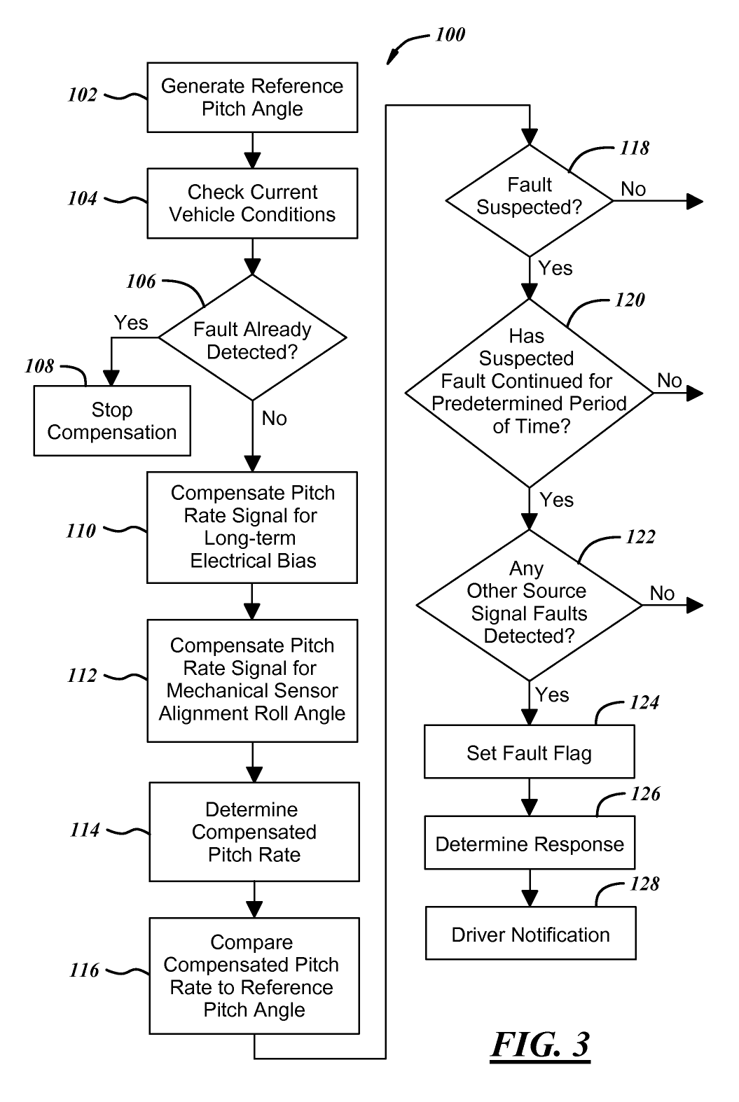

FIG. 3 is a flow chart of a method 100 of pitch rate sensor fault detection according to the inventive subject matter. A reference pitch angle is generated 102 using available signals other than the pitch rate, as pitch rate is the signal to be verified. Any one of the methods discussed infra may be used to generate the reference pitch angle.

Current vehicle conditions are checked 104. Checking current vehicle conditions involves determining whether the longitudinal acceleration signal is of significant magnitude so that signal-to-noise ratio in subsequent calculations will be meaningful. Included in the step of checking current vehicle conditions, a determination is also made as to the appropriateness of assuming zero pitch rate in calculations.

A check is made to determine 106 whether a fault has already been detected. In the event a fault has already been detected, the pitch rate electrical and mechanical bias compensation to the pitch rate signal is stopped 108. This ensures that unnecessary and/or unwanted compensation is avoided.

In the event a fault has not already been detected, the compensation 110 for the long term electrical bias occurs. In the example herein, minute adjustment through logic is used. The electrical bias is updated during straight line driving (i.e., when the turning condition is not met) through logic as follows:

$$\begin{matrix}{ω}_{y temp} = {ω}_{y} - {ɛ}_{E} & ( 12 ) \\ \frac{d {ɛ}_{E}}{d t} = {γ}_{E} \cdot sgn ( {ω}_{ytemp} ) & ( 13 )\end{matrix}$$

where ε_{E} is a calculated electrical bias, ω_{ytemp} is a temporary variable, and γ_{E} is an adjustment rate.

After compensating the electrical bias, a compensation 112 for the mechanical long-term sensor alignment roll angle occurs. In the example herein, minute adjustment through logic is also used as follows:

$$\begin{matrix}{ω}_{ytemp} = {ω}_{y} - {ɛ}_{E} - {ω}_{z} \cdot tan φ & ( 14 ) \\ \frac{d ( tan φ )}{d t} = {γ}_{M} \cdot sgn ( {ω}_{ytemp} \cdot {ω}_{z} ) & ( 15 )\end{matrix}$$

where φ is a calculated alignment roll angle, ω_{ytemp} is a temporary variable, and γ_{M} is an adjustment rate.

The calculated alignment roll angle, φ, is low-pass filtered to minimize chattering noises:

φ_{FLT}=f_{B}·φ_{FLT}+(1−f_{B})·φ (16)

where φ_{FLT} is the filtered alignment roll angle, and fB is a constant determined based on filter bandwidth.

The compensated pitch rate signal for long-term mechanical sensor alignment roll angle is then determined 114 as follows:

ω_{ycomp}=COS φ_{FLT}·(φ_{y}−ε_{E}−ω_{z}·tan θ_{FLT}) (17)

A comparison 116 is made between the compensated pitch rate signal, ω_{ycomp}, and the reference pitch angle θ_{ref} through kinematics relation and the dynamic interaction related by vehicle suspension. During the comparison 116 a fault should not be declared under a plausible bias due to imperfect compensation of electrical and mechanical bias, nor when the accuracy of reference vehicle pitch angle is in question.

The comparison can take place in many forms. For example, a high pass filtered reference pitch angle can be compared to a high pass filtered version of the integration of the compensated pitch rate signal. When the two differ and the latter signal, (integrated compensation pitch rate) is nonzero, a fault is suspected 118.

In another example, a low pass filtered version of the derivative of the reference pitch angle is compared to the compensated pitch rate signal. When the two differ, and the pitch rate signal is nonzero, a fault is suspected 118.

In yet another example, a Kalman filter utilizing the suspension dynamic relation between pitch angle acceleration, pitch angle rate, and pitch angle is compared to the reference pitch angle, θ_{ref}, and the compensated pitch rate, ω_{ycomp}.

In this example, the inventive subject matter provides an observer utilizing both the suspension dynamics and kinematics relationship between the pitch angle and rate in the comparison. This example is robust to suspension parameter variations and uncertainties. A mass-spring system can describe this example as follows:

$$\begin{matrix}\dot{x} = [ \begin{matrix}0 & 1 \\ - k & - c\end{matrix} ] x + [ \begin{matrix}0 \\ 1\end{matrix} ] d , x = [ \begin{matrix}{θ}_{y} \\ {\dot{θ}}_{y}\end{matrix} ] , & ( 18 ) \\ y = [ \begin{matrix}{c}_{11} & {c}_{12} \\ {c}_{21} & {c}_{22}\end{matrix} ] x + f & ( 19 )\end{matrix}$$

where k is the torsional spring stiffness, or pitch stiffness, of the suspension, c is the pitch damping coefficient of the suspension, f is the pitch sensor fault or error. Because the pitch stiffness and damping a vehicle may be nonlinear and may vary between vehicles and configurations, these parameter uncertainties can be combined into another term d, viewed as disturbances (see Equation 18). Because the measurements can be defined as any linear combination of pitch angle and pitch rate, c₁₁ and c₂₂ are design parameters.

Based on the model of equations 18 and 19, the observer is defined as:

$$\begin{matrix}\dot{\hat{x}} = [ \begin{matrix}0 & 1 \\ - k & - c\end{matrix} ] \cdot {x}^{⋒} + [ \begin{matrix}1 & 0 \\ 0 & 0\end{matrix} ] \cdot ( y - \hat{y} ) , & ( 20 ) \\ y = [ \begin{matrix}1 & 1 \\ 0 & 1\end{matrix} ] \cdot [ \begin{matrix}{θ}_{yref} \\ {ω}_{ycomp}\end{matrix} ] , & ( 21 ) \\ \hat{y} = [ \begin{matrix}1 & 1 \\ 0 & 1\end{matrix} ] \cdot \hat{x} . & ( 22 )\end{matrix}$$

A residual, which is an indicator of the pitch rate sensor fault, is defined as:

residual=[1−1]·(y−ŷ) (23)

It can be shown that the transfer function from disturbance to residual is:

TF_{d->residual}≡0 (24)

The transfer function from pitch angle estimation error to residual is:

$${TF}_{pitch\_angle \_err \to residual} = \frac{s}{s + 1} \qquad ( 25 )$$

where s is the Laplace operand. Similarly, the transfer function from pitch rate fault to residual is:

$${TF}_{pitch\_rate \_err \to residual} = - \frac{1}{s + 1} . \qquad ( 26 )$$

The transfer functions show that a pitch rate fault will stand out in the residual while a roll angle estimation error will appear as only transient noise. Moreover, suspension characteristic changes, modeled as disturbance, d, do not affect the residual at all. Therefore, an advantage of this example is that according to the inventive subject matter, the same observer design may be applied to various vehicle platforms without tuning.

The residual is compared to a pre-calibrated threshold. In general, the pre-calibrated threshold may be constructed based on the vehicle dynamics as well as the sensor specification. The basic requirement for the threshold is that it allows for possible vehicle parameter variations and sensor offset/drift within the sensor specification. Furthermore, a dynamic threshold depending on the vehicle states may have a performance/robustness advantage. The threshold is kept tight for fast fault detection, when the vehicle is operating under normal conditions such as during regular driving on normal road surfaces. When the vehicle is maneuvering on a steep grade or is unstable, the threshold can be increased since these situations occur much less frequently and robustness of the fault detection is more of a concern.). If the residual exceeds the threshold, a fault is suspected 118.

Upon suspicion of a fault 118, several factors are considered in order to conclude the existence of a pitch rate sensor fault and set a fault flag 124. In one embodiment, the inventive subject matter will consider if the suspected fault condition occurs for at least a predetermined amount of time 120, during which time no other fault is detected 122 from the source signals used to generate the reference pitch angle, θ_{ref}, or compensate the pitch rate signal, ω_{ytemp}. In another embodiment, an added condition checking for a nonzero pitch rate signal, which is a normal value, will facilitate a faster detection. When a pitch rate signal has an in-range failure, the value of the pitch rate signal must be non-zero for a predetermined period of time. Therefore, if a fault flag and a non-zero pitch rate signal occur at the same time, there is a higher confidence that the sensor is at fault, which facilitates a faster detection.

The pitch rate signal has been known to stick to a constant value, requiring special fault detection. The inventive subject matter has the capability to distinguish a “sticking” fault in the pitch rate sensor from any another type of fault that may occur in the pitch rate sensor. If the pitch rate sensor signal is constant for a predetermined time, and the suspension pitch rate (calculated from longitudinal acceleration) is non-zero for a predetermined period of time, then a fault is suspected 118. If this situation arises for a predetermined number of occurrences, then a “sticking” fault flag is initiated.

According to the method of the inventive subject matter, if either a fault flag or a sticking signal fault flag are indicated, the controller will determine an appropriate response to the pitch rate sensor error 126. The response can be in the form of shutting down a safety system or shutting down a subsystem of the safety system, for example, the yaw/roll stability control.

Another response of the controller may be to respond to the pitch rate sensor error by compensating for information that would normally be obtained from the pitch rate sensor. This may be the controller compensating for pitch rate sensor error by using signals from a combination of sensors, including, but not limited to, the lateral accelerometer, the longitudinal accelerometer, the vertical accelerometer, the yaw rate sensor, the roll rate sensor, wheel speed sensors, the steering angle sensor, and steering angle position sensors (road wheel sensors).

As part of the controller response, a notification is provided 128 of the pitch rate sensor problem is provided to the vehicle operator.

The observer described in the fault detection system and method herein, utilizes suspension dynamics and kinematics relationships between pitch angle and pitch rate. The same design can be applied to various vehicle platforms and do not require tuning. Further, the inventive subject matter considers possible false sensor fault detection due to sensor offset, induced either due to electrical or kinematical reasons. False detection is prevented by compensating the pitch rate sensor signal as described herein. Another advantage of the inventive subject matter is that the pitch rate signal is directly related to the reference pitch angle through a second order suspension model. The system and method of the inventive subject matter isolates a pitch rate sensor fault effectively and rapidly. The model-based system and method for pitch rate sensor fault decouples uncertainties and disturbances to provide a robust analytical approach.

While particular embodiments of the invention have been shown and described, numerous variations and alternate embodiments will occur to those skilled in the art. Accordingly, it is intended that the invention be limited only in terms of the appended claims.

What is claimed is:

1. A method of detecting a pitch rate sensor fault comprising the steps of:
utilizing a kinematic relationship of a plurality of sensor signals other than a signal from a pitch rate sensor to generate a reference pitch angle;
adjusting a pitch rate sensor signal for a plurality of valid signal biases toward a compensated pitch rate sensor signal;
comparing the reference pitch angle and the compensated pitch rate to identify a suspected pitch rate sensor fault; and
verifying a plurality of predetermined parameters in relation to the suspected pitch rate sensor fault to confirm the suspected pitch rate sensor fault to be an actual fault.

2. The method of claim 1 wherein the step of utilizing a kinematic relationship of a plurality of sensor signals further comprises a longitudinal acceleration signal, a yaw rate signal, a lateral velocity signal and a vehicle pitch angle signal.

3. The method of claim 2 wherein the step of generating a reference pitch angle further comprises applying a steering wheel angle signal.

4. The method of claim 1 wherein the step of utilizing a kinematic relationship of a plurality of sensor signals further comprises using a longitudinal acceleration and a suspension pitch motion derived from the plurality of sensor signals.

5. The method of claim 1 wherein the step of utilizing a kinematic relationship of a plurality of sensor signals further comprises utilizing a steering wheel angle signal, a yaw rate signal, a lateral acceleration signal and a vehicle longitudinal speed.

6. The method of claim 1 wherein the step of utilizing a kinematic relationship of a plurality of sensor signals further comprises utilizing a roll rate signal and a yaw rate signal during steady state vehicle turning.

7. The method of claim 1 wherein the step of verifying a plurality of predetermined parameters in relation to the suspected pitch rate sensor fault further comprises:
setting a fault flag; and
providing a notification of the fault flag being set.

8. The method of claim 7 further comprising the step of adjusting an output of a safety system as a result of confirmation of an actual fault.

9. The method of claim 8 wherein the step of adjusting an output of a safety system further comprises shutting down the safety system.

10. The method of claim 8 wherein the step of adjusting an output of a safety system further comprises adjusting an output of a sub-system of the safety system.

11. The method of claim 7 further comprising the step of adjusting a safety system to compensate for a faulty pitch rate sensor.

12. The method of claim 1 further comprising the step of monitoring current vehicle conditions to verify a validity of the plurality of sensor signals being used to generate the reference pitch angle.

13. The method of claim 1 further comprising the steps of:
detecting a fault in a signal other than the pitch rate sensor signal; and
preventing compensation of the pitch rate sensor signal.

14. The method of claim 1 wherein the step of adjusting a pitch rate sensor signal for a plurality of valid signal biases further comprises the steps of:
adjusting electrical long-term bias at each of a plurality of sampling times; and
adjusting a mechanical long-term sensor alignment roll angle at each sampling time.

15. The method of claim 14 wherein the step of adjusting a mechanical long-term sensor alignment roll angle at each sampling time further comprises the step of preventing chattering magnitude from exceeding a predetermined accuracy.

16. The method of claim 1 wherein the step of comparing the reference pitch angle and the compensated pitch rate signal further comprises the step of comparing a high-pass filtered reference pitch angle to a high-pass filtered integration of the compensated pitch rate signal.

17. The method of claim 1 wherein the step of comparing the reference pitch angle and the compensated pitch rate signal comprises the step of comparing a low-pass filtered derivative of the reference pitch angle to the compensated pitch rate signal.

18. The method of claim 1 wherein the step of comparing the reference pitch angle and the compensated pitch rate signal comprises the steps of:
applying a Kalman filter to a suspension dynamic relation between a pitch angle acceleration, a pitch angle rate, and a pitch angle; and
comparing the filtered suspension dynamic to the reference pitch angle and the compensated pitch rate.

19. The method as claimed in claim 1 wherein the step of verifying a plurality of predetermined parameters in relation to the suspected pitch rate sensor fault further comprises the steps of:
detecting the suspected pitch rate sensor fault to occur for at least a predetermined amount of time; and
during the predetermined amount of time, no other fault is detected from the plurality of signals used to generate the reference pitch angle or the compensated pitch rate sensor signal.

20. The method as claimed in claim 19 further comprising the step of checking for a nonzero pitch rate signal.

21. The method as claimed in claim 1 wherein the step of verifying a plurality of predetermined parameters in relation to the suspected pitch rate sensor fault further comprises the steps of:
detecting a constant pitch rate sensor signal for a predetermined period of time;
detecting a non-zero pitch rate for a predetermined period of time;
detecting a predetermined number of occurrences for both the pitch rate sensor signal being constant and the non-zero pitch rate; and
identifying the suspected pitch rate sensor fault to be a sticking fault.

22. A system for detecting a pitch rate sensor fault comprising:
a plurality of sensor signals from an active safety control system;
a controller for developing a kinematic relationship of the plurality of sensor signals to generate a reference pitch angle, a compensated pitch rate and to compare the reference pitch angle to the compensated pitch rate to identify a suspected pitch rate sensor fault; and
a notification signal provided by the controller upon verification of the suspected pitch rate sensor fault to be an actual fault.

23. The system as claimed in claim 22 wherein the kinematic relationship to generate the reference pitch angle further comprises a longitudinal acceleration signal, a yaw rate signal, a lateral velocity and a vehicle pitch angle signal.

24. The system as claimed in claim 23 wherein the kinematic relationship to generate the reference pitch angle further comprises a steering wheel angle signal.

25. The system as claimed in claims 22 wherein the kinematic relationship to generate the reference pitch angle further comprises a longitudinal acceleration and a suspension pitch motion.

26. The system as claimed in claims 22 wherein the kinematic relationship to generate the reference pitch angle further comprises a steering wheel angle signal, a yaw rate signal, a lateral acceleration signal, and a vehicle longitudinal speed.

27. The system as claimed in claims 22 wherein the kinematic relationship to generate the reference pitch angle further comprises a roll rate signal and a yaw rate signal during a steady state vehicle turning event.

28. The system as claimed in claim 22 further comprising a fault flag indicator provided by the controller upon verification of an actual fault.

29. The system as claimed in claim 22 further comprising an adjusted output from the controller to a safety system or a sub-system of the safety system upon verification of an actual fault.

30. The system as claimed in claim 23 wherein the adjusted output further comprises a signal from the controller to compensate the safety system or sub-system of the safety system for information normally obtained from a pitch rate sensor.

31. The system as claimed in claim 22 further comprising a signal from the controller to shut-down a safety system or a sub-system of the safety system upon verification of an actual fault.
